(19) United States
(12) Patent Application Publication
(10) Pub. No.: US 2025/0136195 A1
(43) Pub. Date: May 1, 2025

(54) CAB FOR AN AGRICULTURAL WORK VEHICLE

(71) Applicant: CLAAS KGaA mbH, Harsewinkel (DE)

(72) Inventors: Alexander Quednau, Altbach (DE); Natalie Mildt, Altbach (DE); Markus Grevinga, Saerbeck (DE); Markus Matthies, Bielefeld (DE); Thomas Wagner, Steinhagen (DE); Bert Spindler, Marienfeld (DE); Philipp Klaevers, Marienfeld (DE); Karim Jedlitschka, Halle (Westfalen) (DE)

(73) Assignee: CLAAS KGaA mbH, Harsewinkel (DE)

(21) Appl. No.: 18/931,344

(22) Filed: Oct. 30, 2024

(30) Foreign Application Priority Data
Oct. 30, 2023 (DE) 10 2023 129 946.8

(51) Int. Cl. B62D 33/06; B60Q 3/60; B60Q 3/74; B60R 1/27

(52) U.S. Cl. CPC B62D 33/0617; B60Q 3/60; B60Q 3/74; B60R 1/27; B60Q 2800/20; B60R 2300/8046

(57) ABSTRACT

A cab for an agricultural work vehicle. The cab comprises a cab frame with a frame structure which has two A-pillars provided in the front region thereof and two B-pillars at a distance therefrom in the rear region, which are connected to one another at their ends by frame segments extending in the longitudinal direction and in the transverse direction of the cab. The A-pillars and B-pillars extend substantially vertically and accommodate a cab roof. The cab frame of the cab is designed as modular and comprises a lighting structure integrated into the frame structure with the cab having a control unit configured to control the lighting structure for at least partial illumination of one or more working areas and/or visible areas of the agricultural work vehicle.

### CROSS REFERENCE TO RELATED APPLICATION

This application claims priority under 35 U.S.C. § 119 to German Patent Application No. DE 10 2023 129 946.8 filed Oct. 30, 2023, the entire disclosure of which is hereby incorporated by reference herein. This application is related to U.S. application Ser. No. ______ (attorney-docket number 15191-24020A (P05780/8), which is incorporated by reference herein in its entirety.

### TECHNICAL FIELD

The present invention relates to a cab for an agricultural work vehicle and an agricultural work vehicle with a cab.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

WO 2023/144663 A1 discloses a cab for an agricultural work vehicle. It discloses an agricultural work vehicle designed as a tractor which is designed with a fastening system which enables the flexible and detachable attachment of functional elements to pillars of the cab as required. The functional elements are referred to as lighting units, display units or sensor devices, which are releasably attached to the outside of a pillar of the cab by means of a mounting element designed as a rail element. Lights are arranged or positioned on the cab roof of the cab to illuminate the tractor. The additional lighting units attached to the pillars of the cab by means of the mounting elements have the task of visualizing specific information for vehicles or persons located in the vicinity of the tractor. The given lighting units are specifically adapted to the type of information to be transmitted. For example, a lighting unit may serve to illuminate an obstacle. Another use of a lighting unit is for communication in a leader-follower configuration of work vehicles.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic and exemplary perspective view of an agricultural work vehicle with a cab.

FIG. 2A illustrates a schematic and exemplary perspective view of a cab frame of the cab.

FIG. 2B illustrates a schematic and exemplary perspective view of another version of the cab frame of the cab.

FIG. 3 illustrates a schematic and exemplary perspective view of the cab according to FIG. 1.

FIG. 4 illustrates a schematic and exemplary front view of the cab according to FIG. 3.

FIG. 5 illustrates a schematic and exemplary rear view of the cab according to FIG. 3.

### DETAILED DESCRIPTION

As discussed in the background, WO 2023/144663 A1 discloses a cab for an agricultural work vehicle. The background to the fastening system disclosed in WO 2023/144663 A1 is an individual adaptation of the cab produced in a basic version in order to be able to realize different customer requirements or to simplify retrofitting or conversion by replacing or adding functional elements.

In contrast, in one or some embodiments, a cab for an agricultural work vehicle is disclosed which may be used on agricultural work vehicles of a plurality of different types across systems, wherein the cab is designed with a lighting structure uniform for all work vehicles.

In one or some embodiments, the cab comprises a cab frame with a frame structure which may have one or both of a plurality of A-pillars (such as two A-pillars positioned in the front region thereof) and/or a plurality of B-pillars (such as two B-pillars positioned at a distance therefrom in the rear region), with the plurality of A-pillars and/or the plurality of B-pillars being connected to one another at their ends by frame segments extending in the longitudinal direction and/or in the transverse direction of the cab, wherein the plurality of A-pillars and/or the plurality of B-pillars are arranged or positioned extending at least substantially vertically (e.g., substantially or entirely) and accommodate a cab roof.

In one or some embodiments, the frame structure surrounds the interior of the cab. The at least substantially vertical A-pillars and B-pillars may extend between a base element and the cab roof.

In one or some embodiments, the cab frame of the cab is designed as modular and comprises a lighting structure attached to, integrated into, or partly or entirely incorporated within the frame structure, and that the cab has a control unit which is configured to control the lighting structure for at least partial illumination of one or more work areas and/or one or more visible areas of the agricultural work vehicle.

In one or some embodiments, the effort for installing the lighting structure on the cab may be reduced compared to cabs known from the prior art, as there is less or no need for a fastening system for the individual arrangement of lighting units. For this purpose, at least the frame structure may be designed cross-system. For cross-system use of the cab, the frame structure and the lighting structure integrated therein may be substantially (or entirely) designed as identical parts that are used for different types of work vehicles. The cross-system use of the frame structure with the lighting structure integrated therein of the cab for different types of agricultural work vehicles may therefore be achieved by the uniform design of the frame structure, regardless of the type of work vehicle, as well as the control, using the control unit, of the also uniformly designed lighting structure integrated in the frame structure. The control by the control unit the uniformly designed lighting structure integrated into the frame structure may be specifically adapted to the requirements of the different agricultural work vehicles.

In one or some embodiments, work areas may be areas to be illuminated, such as lying in front of and/or behind attachments or front attachments on the agricultural work vehicle, on which work is to be carried out. Work areas may be located in any one, any combination, or all of: the front of the agricultural work vehicle; to the side of the agricultural work vehicle; or behind the agricultural work vehicle. Visible areas may be areas to be temporarily illuminated in the immediate vicinity of the agricultural work vehicle, for example a step up to the cab, or a rear power lift located in the rear area, or a trailer or coupling device. In this regard, the immediate vicinity of the agricultural work vehicle may comprise areas less than 3 feet from the agricultural work vehicle, less than 2 feet from the agricultural work vehicle, or less than 1 foot from the agricultural work vehicle.

In one or some embodiments, the lighting structure integrated into the frame structure may comprise externally visible components of the lighting structure that abut flush with the frame structure (e.g., the contour or shape of a section of the lighting structure that is integrated into a component of the frame structure is designed to follow it).

In particular, the lighting structure may comprise adaptive light modules. The adaptive light modules may be adaptive in one or more aspects, such as any one, any combination, or all of: light intensity of the emitted light; wavelength of the emitted light; or beam angle of the emitted light. Other aspects are contemplated. The individual light modules may be designed as one part or several parts.

In one or some embodiments, the control unit may be configured to automatically control the light intensity and/or the wavelength of the emitted light of the adaptive light modules. Furthermore, the control unit may be configured to automatically adapt the beam angle of the adaptive light modules. As discussed in more detail below, various lighting algorithms may be used in order to control the adaptive light modules based on the type of agricultural work vehicle and/or the operation of the agricultural work vehicle. Responsive to determining the type and/or the operation of the agricultural work vehicle, the control unit may access the respective lighting algorithm, in order to adaptively control based on any one, any combination, or all of: light intensity of the emitted light; wavelength of the emitted light; or beam angle of the emitted light.

In particular, light modules of the lighting structure integrated into the A-pillars may extend in a vertical direction substantially (e.g., at least 75%, at least 80% at least 90%, or at least 95%) or entirely over the length of the A-pillars on surface sections of the A-pillars facing in the direction of forward travel. Furthermore, one or more visualization devices may be arranged or positioned on the A-pillars on their sides facing the interior of the cab. The visualization devices may completely or partially (e.g., at least 30%, at least 35%, at least 40%, at least 45%, at least 50%, at least 55%, at least 60%, at least 65%, at least 70%, at least 75%, at least 80% at least 90%, or at least 95%) cover the given A-pillar. The visualization devices may include one or more cameras that capture one or more images of the viewing area covered by the A-pillars and may transmit the one or more images to the one or more visualization devices.

Alternatively or additionally, light modules of the lighting structure may be integrated into a front face of the cab roof and extend (e.g., at least 75%, at least 80% at least 90%, or at least 95%) or entirely across the width of the cab roof.

Light modules of the lighting structure may also be integrated into the frame segments connecting the A-pillars and the B-pillars or into the side surfaces of the cab roof extending in the longitudinal direction of the cab.

In particular, light modules of the lighting structure integrated into the B-pillars may extend in a vertical direction substantially (e.g., at least 75%, at least 80% at least 90%, or at least 95%) or entirely over the length of the A-pillars on surface sections of the B-pillars facing in the direction of forward travel. Furthermore, one or more visualization devices may be arranged or positioned on the B-pillars on their sides facing the interior of the cab. The one or more visualization devices may completely or partially (e.g., at least 30%, at least 35%, at least 40%, at least 45%, at least 50%, at least 55%, at least 60%, at least 65%, at least 70%, at least 75%, at least 80% at least 90%, or at least 95%) cover the given B-pillar. The one or more visualization devices may include one or more cameras that capture one or more images of the viewing area covered by the B-pillars and may transmit the one or more images to the one or more visualization devices.

In one or some embodiments, a holding device for a mirror replacement of a mirror replacement system extending outwards in the transverse direction of the cab may be arranged or positioned on the A-pillars and/or on the lateral frame segments connecting the A-pillars and the B-pillars to each other. The mirror replacement system may comprise one or more optical sensors arranged or positioned in the holding devices, which may detect at least the rear area of the agricultural work vehicle. In one or some embodiments, the optical sensors comprise cameras (e.g., digital cameras).

Furthermore, a light module with a beam direction opposite to the rear of the cab may be integrated into the given holding device.

Furthermore, one or more parts of the lighting structure may be part of the mirror replacement system. In this way, the one or more parts of the lighting structure may be specifically controlled in order to illuminate the detection area of the optical sensors of the mirror replacement system as desired.

In one or some embodiments, the control unit is configured to control the individual light modules independently of each other. Accordingly, regardless of the type of agricultural work vehicle, each cab may be designed with a uniform lighting structure. This may reduce manufacturing costs and may lead to more straightforward manufacturing. In this regard, by adapting control algorithms that may be stored or saved in the control unit, it is possible to individualize and/or adapt the control of the individual light modules of the uniformly designed lighting structure to different types of agricultural work vehicles. For example, responsive to determining that the agricultural work vehicle is of the first type, the control unit may automatically access a first type lighting control algorithm and accordingly control the lighting with the first type lighting control algorithm. Similarly, responsive to determining that the agricultural work vehicle is of the second type, the control unit may automatically access a second type lighting control algorithm and accordingly control the lighting with the second type lighting control algorithm.

In one or some embodiments, an agricultural work vehicle with a cab is disclosed. In particular, the agricultural work vehicle may be equipped with the cab as discussed herein, wherein the control unit may be configured to control one or more individual light modules of the lighting structure depending on field driving or road driving specific to the application. In particular, the control unit may be configured to determine at least partly automatically (e.g., fully automatically without driver input or at least partially automatically based on operator input) determining current operation, such as current driving operation, of the agricultural work vehicle, such as whether the agricultural work vehicle is performing a first type of driving versus a second type of driving (e.g., driving on a road or driving in the field). Responsive to the determination as to the first type of driving versus the second type of driving and to the determination as to the first type of agricultural work vehicle versus the second type of agricultural work vehicle, different lighting algorithms may be accessed/used (e.g., first type of driving-first type of agricultural work vehicle lighting algorithm; second type of driving-first type of agricultural work vehicle lighting algorithm; first type of driving-second type of agricultural work vehicle lighting algorithm; second type of driving-second type of agricultural work vehicle lighting algorithm) In particular, responsive to at least partly automatically determining whether the agricultural work vehicle is field driving, the control unit may access a field driving lighting control algorithm configured for field driving (e.g., lighting that is tailored to illuminating portions in any one of the front, the left side, the right side, or the rear of the agricultural work vehicle needed to be illuminated for the driver of the agricultural work vehicle to see). As one example, the field driving lighting control algorithm may be configured to light areas to reduce possibility of collisions with immovable objects or animals in the path of the agricultural work vehicle. Responsive to at least partly automatically determining whether the agricultural work vehicle is road driving, the control unit may access a road driving lighting control algorithm configured for controlling the lighting tailored to road driving (e.g., focused on lighting the road and optionally lighting for reducing hazardous driving conditions of road driving). In this regard, the road driving lighting control algorithm is different from the field driving lighting control algorithm.

In one or some embodiments, the field driving lighting control algorithm is generic across the different types of agricultural work vehicles (e.g., the same field driving lighting control algorithm is used for a tractor or a harvester). Alternatively, the field driving lighting control algorithm is different for the different types of agricultural work vehicles. In this regard, the control unit may determine whether the agricultural work vehicle is a first type of agricultural work vehicle or a second type of agricultural work vehicle.

Various types of agricultural work vehicles are contemplated, including: tractor or harvester; tractor, combine harvester, or forage harvester; or combine harvester or forage harvester. In this regard, a variety of combinations are contemplated (e.g., a tractor-field driving lighting control algorithm is used for and tailored to tractor driving with the tractor-field driving lighting control algorithm used responsive to the control unit determining: that the agricultural work vehicle is a tractor; and that the agricultural work vehicle is currently driving in the field; a harvester-field driving lighting control algorithm is used for and tailored to harvester driving with the harvester-field driving lighting control algorithm used responsive to the control unit determining: that the agricultural work vehicle is a harvester; and that the agricultural work vehicle is currently driving in the field; a combine harvester-field driving lighting control algorithm is used for and tailored to combine harvester driving with the combine harvester-field driving lighting control algorithm used responsive to the control unit determining: that the agricultural work vehicle is a combine harvester; and that the agricultural work vehicle is currently driving in the field; and a forage harvester-field driving lighting control algorithm is used for and tailored to forage harvester driving with the forage harvester-field driving lighting control algorithm used responsive to the control unit determining: that the agricultural work vehicle is a forage harvester; and that the agricultural work vehicle is currently driving in the field).

In one or some embodiments, the road driving lighting control algorithm is generic across the different types of agricultural work vehicles (e.g., the same road driving lighting control algorithm is used for a tractor or a harvester). Alternatively, the road driving lighting control algorithm is different for the different types of agricultural work vehicles. For example, responsive to determining that the agricultural work vehicle is of the first type and the agricultural work vehicle is field driving, the control unit may automatically access a first type field driving lighting control algorithm and accordingly control the lighting with the first type field driving lighting control algorithm. Responsive to determining that the agricultural work vehicle is of the first type and the agricultural work vehicle is road driving, the control unit may automatically access a first type road driving lighting control algorithm and accordingly control the lighting with the first type road driving lighting control algorithm. Similarly, responsive to determining that the agricultural work vehicle is of the second type and the agricultural work vehicle is field driving, the control unit may automatically access a second type field driving lighting control algorithm and accordingly control the lighting with the second type field driving lighting control algorithm. Responsive to determining that the agricultural work vehicle is of the second type and the agricultural work vehicle is road driving, the control unit may automatically access a second type road driving lighting control algorithm and accordingly control the lighting with the second type road driving lighting control algorithm.

As discussed above, various types of agricultural work vehicles are contemplated, including tractor or harvester, or tractor, combine harvester, or forage harvester (e.g., a tractor lighting control algorithm is used for and tailored to the tractor with the tractor lighting control algorithm used responsive to the control unit determining: that the agricultural work vehicle is a tractor; a harvester lighting control algorithm is used for and tailored to the harvester with the harvester lighting control algorithm used responsive to the control unit determining: that the agricultural work vehicle is a harvester; a combine harvester lighting control algorithm is used for and tailored to the combine harvester with the combine harvester lighting control algorithm used responsive to the control unit determining: that the agricultural work vehicle is a combine harvester; and a forage harvester lighting control algorithm is used for and tailored to the forage harvester with the forage harvester lighting control algorithm used responsive to the control unit determining: that the agricultural work vehicle is a forage harvester).

In one or some embodiments, the various types of agricultural work vehicles (e.g., tractor or harvester, or tractor, combine harvester, or forage harvester) may perform various operations (such as field driving and road driving), resulting in different combinations (e.g., a tractor-road driving lighting control algorithm is used for and tailored to tractor driving with the tractor-road driving lighting control algorithm used responsive to the control unit determining: that the agricultural work vehicle is a tractor; and that the agricultural work vehicle is currently driving on the road; a harvester-road driving lighting control algorithm is used for and tailored to harvester driving with the harvester-road driving lighting control algorithm used responsive to the control unit determining: that the agricultural work vehicle is a harvester; and that the agricultural work vehicle is currently driving on the road; a combine harvester-road driving lighting control algorithm is used for and tailored to combine harvester driving with the combine harvester-road driving lighting control algorithm used responsive to the control unit determining: that the agricultural work vehicle is a combine harvester; and that the agricultural work vehicle is currently driving on the road; and a forage harvester-road driving lighting control algorithm is used for and tailored to forage harvester driving with the forage harvester-road driving lighting control algorithm used responsive to the control unit determining: that the agricultural work vehicle is a forage harvester; and that the agricultural work vehicle is currently driving on the road). In this regard, the control unit may be configured for operation across different operations (e.g., field driving versus road driving) and/or for different types of agricultural work vehicles (e.g., tractor versus harvester; tractor versus combine harvester versus forage harvester). Reference may be made to all explanations of the cab according to the invention.

As discussed above, in one or some embodiments, the agricultural work vehicle may comprise a tractor or as a self-propelled harvesting machine, such as a combine harvester or forage harvester. The cab for the agricultural work vehicle may be described in any manner discussed herein.

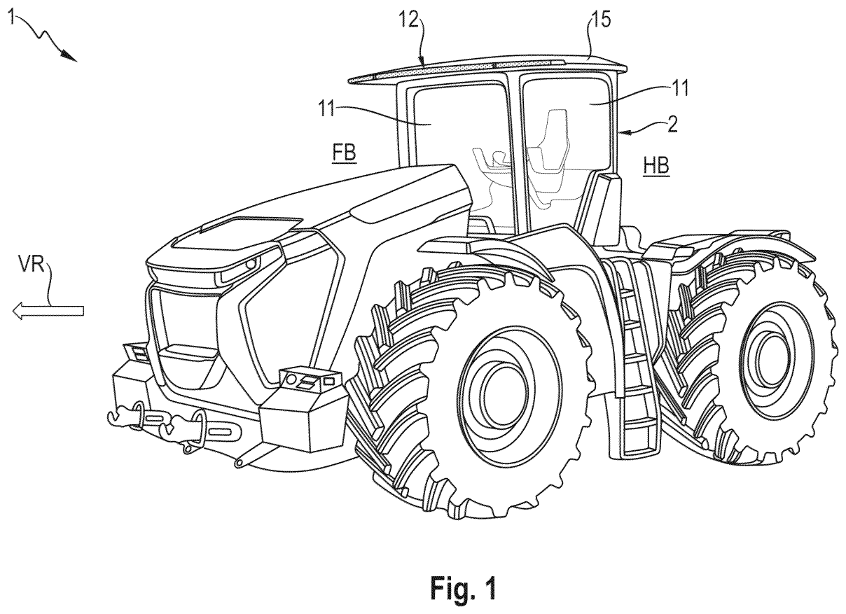

Referring to the figures, FIG. 1 shows a schematic perspective view of an agricultural work vehicle 1 with a cab 2. The agricultural work vehicle 1 may comprise a tractor or a self-propelled harvesting machine (a combine harvester or a forage harvester), which may be equipped with the cross-system cab 2.

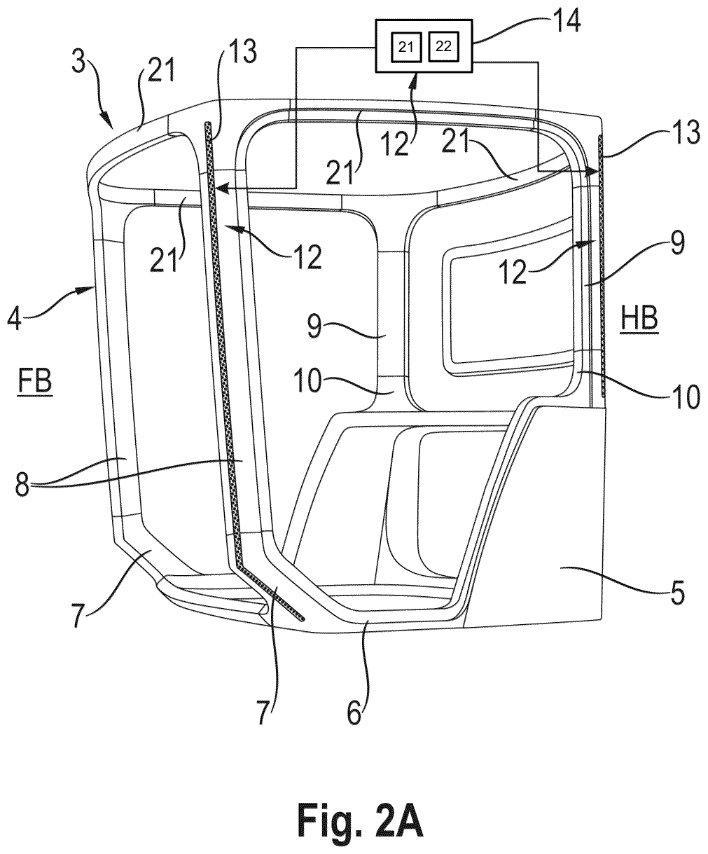

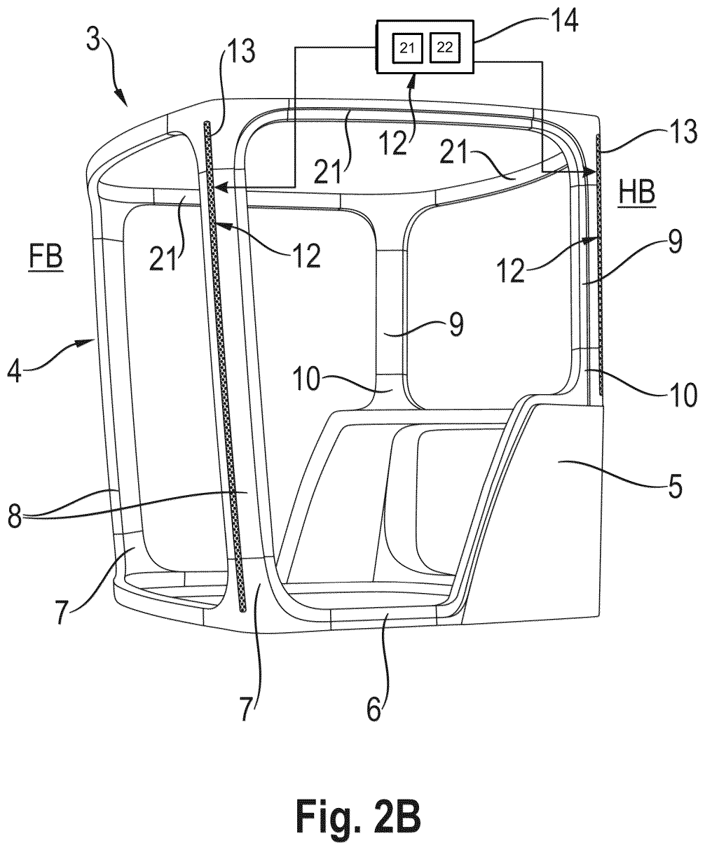

The cab 2 is explained in more detail below with reference to FIG. 2A to FIG. 5. FIG. 2A shows a schematic perspective view of a cab frame 3 of the cab 2 for a work vehicle 1 comprising a harvester. FIG. 2B shows a schematic perspective view of the cab frame 3 of the cab 2 for a work vehicle 1 comprising a tractor.

The cab 2 may comprise the cab frame 3 with a frame structure 4. Furthermore, the cab frame 3 may comprise a base element 5. The frame structure 4 of the cab frame 3 may be designed cross-system so that the frame structure 4 may be used in the different embodiments of work vehicles 1. The base element 5 as illustrated in FIG. 2A and FIG. 2B differs only in the aspects specific to the given work vehicle 1.

In the agricultural work vehicle 1 designed as a harvester (shown in FIG. 2A), the base element 5 has an inclination of two front-side pillar sections 7 of the base element 5 in the front area FB, starting from the floor section 6. The pillar sections 7 may serve to connect the substantially vertically running A-pillars 8 of the frame structure 4 to the base element 5. The inclination of the pillar sections 7 may enable a person located in the cab 2 to see the area directly in front of and/or below the cab 2, which may be necessary and useful for a work vehicle 1 that comprises a harvesting machine. There are two B-pillars 9 in the rear area HB of the cab 2 or the cab frame 3. The two B-pillars 9 may be connected by pillar sections 10 in the rear area HB of the base element 5.

With the agricultural work vehicle 1 designed as a tractor (shown in FIG. 2B), the base element 5 has two front-side pillar sections 7 extending substantially vertically from the floor section 6 in the front area FB. In the rear area HB of the base element 5, this may differ from that shown in FIG. 2B by a modified shape, which may be due to the arrangement of the cab 2 in the area between and above the rear wheels of the tractor-type work vehicle 1.

In one or some embodiments, the pillar sections 10 of the given base element 5 located in the rear area HB may be designed to be identical.

In one or some embodiments, the A-pillars 8 and the B-pillars 9 are connected to each other at their ends by frame segments 21 extending in the longitudinal direction and/or in the transverse direction of the cab 2 as components of the frame structure 4. The two A-pillars 8 and the two B-pillars 9 may be arranged or positioned running substantially vertically and may accommodate a cab roof 15, which may close off the cab 2 at the top.

The free areas within the frame structure 4 between the two A-pillars 8 and the B-pillars 9 and/or between the A-pillars 8 and the B-pillars 9 of the cab frame 3 may be completely closed by individual panes 11. The individual panes 11 need not have any additional frame elements that restrict the free view out of the cab 2, such as to the front and/or to the side. In the instance of a work vehicle 1 comprising a tractor, a correspondingly designed pane in the rear area HB may ensure that a driver of the tractor may see the equipment and the trailer coupling and/or the three-point linkage through the rear pane.

As may be seen in part from the illustrations in FIG. 2A and FIG. 2B, the cab frame 3 comprises a lighting structure 12 integrated into the frame structure 4. The cab 2 may comprise a control unit 14, which is configured to automatically control the lighting structure 12 for at least partial (or total) illumination of one or more work areas and/or viewing areas of the agricultural work vehicle 1.

Control unit 14 may include at least one processor 21 and at least one memory 22. The at least one processor 21 and at least one memory 22 may be in communication (e.g., wired and/or wirelessly) with one another. In one or some embodiments, the processor 46 may comprise a microprocessor, controller, PLA, or the like. Similarly, the memory 22 may comprise any type of storage device (e.g., any type of memory) and may be configured to store control algorithms or the like. In practice, the processor 21 may automatically make determinations, such as whether field travel or road travel and/or the type of agricultural work vehicle 1. Further, the processor 21 may automatically access the respective control algorithm (for automatic execution of the desired respective lighting) from memory 22 responsive to the determination. Though the processor 21 and the memory 22 are depicted as separate elements, they may be part of a single machine, which includes a microprocessor (or other type of controller) and a memory. Alternatively, the processor 21 may rely on the memory 22 for all of its memory needs. The memory 22 may comprise a tangible computer-readable medium that include software that, when executed by the processor 21 is configured to perform any one, any combination, or all of the functionality described herein, such as the functionality of the assistance system.

The processor 21 and the memory 22 are merely one example of a computational configuration for the control unit 14. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

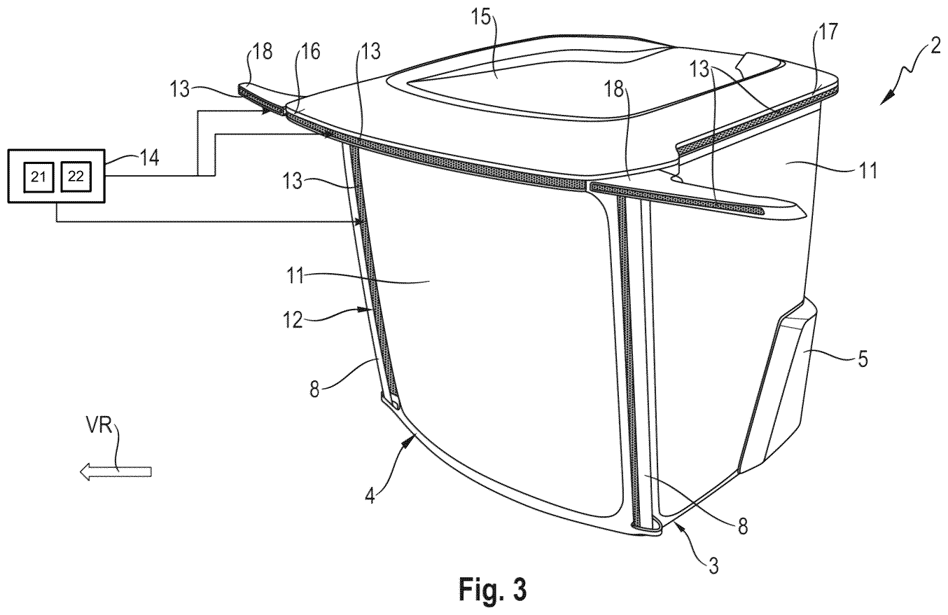

The lighting structure 12 may comprise a plurality of adaptive light modules 13, one, some, or all of which may be integrated in each case in the A-pillar 8 and B-pillar 9. The arrangement and design of additional adaptive light modules 13 of the lighting structure 12 is explained in more detail with reference to FIGS. 3 to 5 below.

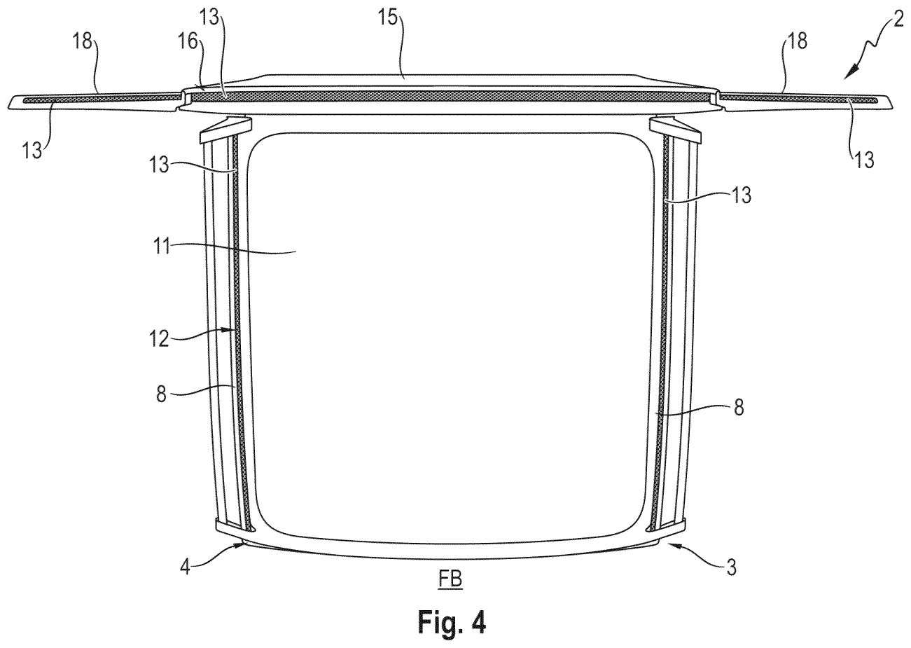

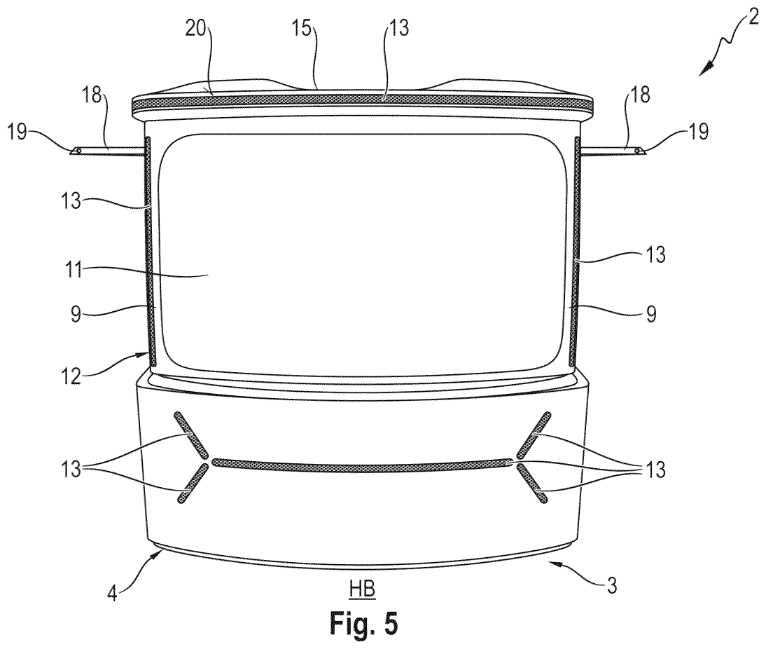

FIG. 3 shows a schematic and exemplary perspective view of the cab 2 according to FIG. 1. FIG. 4 and FIG. 5 show a schematic and exemplary front view of the cab 2 according to FIG. 3 and a rear view of the cab 2 according to FIG. 3.

The light modules 13 of the lighting structure 12 integrated into the two A-pillars 8 may extend in a vertical direction substantially over the length of the A-pillars 8 at surface sections of the A-pillars 8 facing in the direction of forward travel VR.

Alternatively or additionally, light modules 13 of the lighting structure 12 may be integrated into a front face 16 of the cab roof 15 and extend substantially over the width of the cab roof 15.

Also, in one or some embodiments, light modules 13 of the lighting structure 12 may be integrated into the frame segments 21 connecting the A-pillars 8 and the B-pillars 9 to each other and extending in the longitudinal direction of the cab 2, or into side surfaces 17 of the cab roof 15 extending in the longitudinal direction of the cab 2. In one or some embodiments, at least one light module 13 may be integrated into the cab roof 15, which may substantially (e.g., at least 75%, at least 80% at least 90%, or at least 95%) or entirely surround the cab roof 15 in a U-shape, starting from one side surface 17 along a rear face 20 to the opposite side surface 17.

In particular, light modules 13 of the lighting structure 12 integrated into the B-pillars 9 may extend in the vertical direction substantially (e.g., at least 75%, at least 80% at least 90%, or at least 95%) or entirely over the length of the B-pillars 9 at surface sections of the B-pillars 9 facing substantially opposite the direction of forward travel VR.

Furthermore, one or more visualization devices may be arranged or positioned on the A-pillars 8 and/or the B-pillars 9 on their sides facing the interior of the cab 2. The visualization devices may completely or partially cover the given A-pillar 8 and/or B-pillar 9. The one or more visualization devices may comprise one or more cameras that capture one or more images of the viewing area covered by the A-pillars 8 or B-pillars 9 and transmit the one or more images to monitors (e.g., LCD displays) of the visualization devices. This may enable a substantially uninterrupted or clear view out of the cab 2.

In one or some embodiments, a holding device 18 extending outwards in the transverse direction of the cab 2 for a mirror replacement of a mirror replacement system may be arranged or positioned on the A-pillars 8 or on the lateral frame segments 21 connecting the A-pillars 8 and the B-pillars 9 to each other. The mirror replacement system may comprise one or more optical sensors 19 arranged or positioned in the holding devices 18, which may detect at least the rear area of the agricultural work vehicle 1.

Parts of the lighting structure 12 may be part of the mirror replacement system. Therefore, individual light modules 13 of the lighting structure 12 may be specifically controlled by the control unit 14 in order to illuminate the detection area of the optical sensors 19 of the mirror replacement system as desired. Similarly, for example, the laterally arranged or positioned light modules 13, which may extend sectionally in the longitudinal direction of the cab 2, may be automatically switched off by the control unit 14 in order to avoid glare effects during reverse travel by the agricultural work vehicle 1.

Furthermore, a light module 13 with a beam direction opposite to the rear area HB of the cab 2 may be integrated into the given holding device 18.

The individual light modules 13 may be designed in one or more parts. In particular, the light modules 13 may be designed as matrix LEDs.

In one or some embodiments, the control unit 14 is configured to automatically control the light intensity and/or the wavelength of the emitted light of the adaptive light modules 13. Furthermore, the control unit 14 may be configured to automatically adapt the beam angle of the adaptive light modules 13. In this way, improved illumination of work areas and/or visible areas may be achieved by the lighting structure 12.

In one or some embodiments, the control unit 14 is configured to automatically control the individual light modules 13 of the lighting structure 12 independently of each other. Accordingly, regardless of the type of agricultural work vehicle 1, such as tractor or harvester, each cab 2 may be designed with a cross-system uniform lighting structure 12. This may reduce manufacturing costs and/or make manufacturing easier. By adapting control algorithms that may be stored or saved in a memory unit of the control unit 14, it may be possible to individualize and/or adapt the control of the individual light modules 13 of the uniformly designed lighting structure 12 to different types of agricultural work vehicles 1.

In one or some embodiments, the control unit 14 is configured to automatically control individual light modules 13 of the lighting structure 12 depending on field travel or road travel. The control unit 14 may be configured to automatically detect field travel or road travel. In one or some embodiments, the control unit 14 is configured to automatically detect field travel or road travel based on a present location of the agricultural work vehicle 1 (e.g., a present location may be determined via a GPS receiver resident on the agricultural work vehicle 1, with the present location being compared to a map resident in the memory 22 of the control unit 14) and/or based on current operations of the agricultural work vehicle 1 and/or based on analysis of the one or more images generated by the cameras. Responsive to the control unit automatically determining whether the agricultural work vehicle 1 is in the field or on the road, the control unit 14 is configured to automatically control the individual light modules 13 of the lighting structure 12 (e.g., responsive to detecting field travel, the control unit 14 may automatically control the individual light modules 13 of the lighting structure 12 for specific lighting for field travel; responsive to detecting road travel, the control unit 14 may automatically control the individual light modules 13 of the lighting structure 12 for specific lighting for road travel).

Moreover, the control unit 14 may automatically determine whether the agricultural work vehicle 1 is in the field or on the road and/or the type of agricultural work vehicle 1 (e.g., whether the agricultural work vehicle 1 is a tractor or harvester; whether agricultural work vehicle 1 is a combine harvester or a forage harvester). Responsive to the control unit 14 automatically determining whether the agricultural work vehicle 1 is in the field or on the road and the type of agricultural work vehicle 1 (e.g., whether the agricultural work vehicle 1 is a tractor or a harvester; whether the agricultural work vehicle 1 is a combine harvester or a forage harvester), the control unit 14 may control the lighting accordingly (e.g., the control unit 14 automatically determining that the agricultural work vehicle 1 is a tractor and is currently road travel, the control unit 14 may access a specific control algorithm that automatically controls the individual light modules 13 of the lighting structure 12 for specific lighting tailored to road travel for a tractor; the control unit 14 automatically determining that the agricultural work vehicle 1 is a tractor and is currently field travel, the control unit 14 may a specific control algorithm that automatically controls the individual light modules 13 of the lighting structure 12 for specific lighting tailored to field travel for a tractor; the control unit 14 automatically determining that the agricultural work vehicle 1 is a harvester and is currently road travel, the control unit 14 may a specific control algorithm that automatically controls the individual light modules 13 of the lighting structure 12 for specific lighting tailored to road travel for a harvester; the control unit 14 automatically determining that the agricultural work vehicle 1 is a harvester and is currently field travel, the control unit 14 may a specific control algorithm that automatically controls the individual light modules 13 of the lighting structure 12 for specific lighting tailored to field travel for a harvester; the control unit 14 automatically determining that the agricultural work vehicle 1 is a combine harvester and is currently road travel, the control unit 14 may a specific control algorithm that automatically controls the individual light modules 13 of the lighting structure 12 for specific lighting tailored to road travel for a combine harvester; the control unit 14 automatically determining that the agricultural work vehicle 1 is a combine harvester and is currently field travel, the control unit 14 may a specific control algorithm that automatically controls the individual light modules 13 of the lighting structure 12 for specific lighting tailored to field travel for a combine harvester; the control unit 14 automatically determining that the agricultural work vehicle 1 is a forage harvester and is currently road travel, the control unit 14 may a specific control algorithm that automatically controls the individual light modules 13 of the lighting structure 12 for specific lighting tailored to road travel for a forage harvester; the control unit 14 automatically determining that the agricultural work vehicle 1 is a forage harvester and is currently field travel, the control unit 14 may a specific control algorithm that automatically controls the individual light modules 13 of the lighting structure 12 for specific lighting tailored to field travel for a forage harvester)

In this regard, the control unit 14 may control the lighting structure 12 for at least partial illumination of one or more work areas and/or visible areas of the agricultural work vehicle 1 in order to optimize the at least partial illumination, such as to switch it on or switch it off and/or adjust it as required and based on one or more factors, such as one or both of: field travel or road travel; or type of agricultural work vehicle 1 (e.g., whether tractor or harvester; whether combine harvester or forage harvester; or whether tractor, combine harvester, or forage harvester).

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Work vehicle
2 Cab
3 Cab frame
4 Frame structure
5 Base element
6 Floor section
7 Pillar section
8 A-pillar
9 B-pillar
10 Pillar section
11 Pane
12 Lighting structure
13 Light module
14 Control unit
15 Cab roof
16 Front face
17 Side surface
18 Holding device
19 Optical sensor
20 Rear face
21 Processor
22 Memory
FB Front area
HB Rear area
VR Forward direction of travel

1. A cab for an agricultural work vehicle, the cab comprising:
a cab frame being modular in design and including a frame structure which has a plurality of A-pillars positioned in a front region of the cab and a plurality of B-pillars positioned in a rear region of the cab, wherein the plurality of A-pillars are connected to each other, the plurality of B-pillars are connected to each other, and the plurality of A-pillars are connected to the plurality of B-pillars at respective ends by frame segments extending in a longitudinal direction and in a transverse direction of the cab, wherein the cab frame comprises a lighting structure integrated into the frame structure;
a cab roof, wherein the plurality of A-pillars and the plurality of B-pillars are positioned substantially vertically and configured to support the cab roof; and
a control unit configured to control the lighting structure for at least partial illumination of one or both of: one or more working areas; or one or more visible areas of the agricultural work vehicle.

2. The cab of claim 1, wherein the lighting structure comprises at least one adaptive light module.

3. The cab of claim 2, wherein the control unit is configured to automatically control one or both of light intensity or wavelength of emitted light of the at least one adaptive light module.

4. The cab of claim 3, wherein the control unit is further configured to automatically adapt beam angle of the at least one adaptive light module.

5. The cab of claim 2, wherein the at least one adaptive light module of the lighting structure is integrated in one or more of the plurality of A-pillars and extend in a vertical direction substantially over at least a part of length of the one or more the plurality of A-pillars on surface sections of the one or more of the plurality of A-pillars pointing in a direction of forward travel.

6. The cab of claim 5, wherein the at least one adaptive light module of the lighting structure is integrated into a front face of the cab roof and extends at least substantially over a width of the cab roof.

7. The cab of claim 2, wherein the at least one adaptive light module of the lighting structure is integrated into the frame segments connecting the plurality of A-pillars and the plurality of B-pillars to each other and extending in the longitudinal direction of the cab, or into side surfaces of the cab roof extending in the longitudinal direction of the cab.

8. The cab of claim 2, wherein the at least one adaptive light module of the lighting structure integrated in the plurality of B-pillars extend in a vertical direction at least substantially over a length of the B-pillars on surface sections of the plurality of B-pillars substantially opposite a direction of forward travel.

9. The cab according to claim 2, further comprising a holding device extending outwards in a transverse direction of the cab; and
wherein the holding device is configured as a mirror replacement system configured to replace a mirror of the agricultural work vehicle.

10. The cab according to claim 9, wherein the mirror replacement system is positioned on the at least one of the plurality of A-pillars.

11. The cab according to claim 9, wherein the mirror replacement system is positioned on at least one of the frame segments that are lateral connecting the plurality of A-pillars and the plurality of B-pillars to each other.

12. The cab of claim 9, wherein the at least one adaptive light module is configured to generate a beam direction opposite to a rear area of the cab; and
wherein the at least one adaptive light module is integrated into the holding device.

13. The cab of claim 12, wherein one or more parts of the lighting structure are part of the mirror replacement system.

14. The cab of claim 2, wherein the at least one adaptive light module comprise a plurality of adaptive light modules; and
wherein the control unit is configured to automatically control the plurality of adaptive light modules independently of one another.

15. The cab of claim 1, wherein the control unit is further configured to at least partly automatically determine whether the agricultural work vehicle is performing a first type of driving or a second type of driving; and
wherein the control unit is configured to control the lighting structure by:
responsive to determining that the agricultural work vehicle is performing the first type of driving:
automatically access a first type of driving lighting algorithm configured to control the lighting structure at least partly during the first type of driving; and
automatically control the lighting structure according to the first type of driving lighting algorithm; and
responsive to determining that the agricultural work vehicle is performing the second type of driving:
automatically access a second type of driving lighting algorithm configured to control the lighting structure at least partly during the second type of driving; and
automatically control the lighting structure according to the second type of driving lighting algorithm.

16. The cab of claim 15, wherein the first type of driving comprises road driving or the second type of driving comprises field driving; and
wherein the control unit is configured to control the lighting structure by:
responsive to determining that the agricultural work vehicle is performing the road driving:
automatically access a road driving lighting algorithm configured to control the lighting structure at least partly during the road driving; and
automatically control the lighting structure according to the road driving lighting algorithm; and
responsive to determining that the agricultural work vehicle is performing the field driving:
automatically access a field driving lighting algorithm configured to control the lighting structure at least partly during the field driving; and
automatically control the lighting structure according to the field driving lighting algorithm.

17. The cab of claim 1, wherein the control unit is further configured to at least partly automatically determine a type of the agricultural work vehicle comprising at least a first type of agricultural work vehicle and a second type of agricultural work vehicle; and
wherein the control unit is configured to control the lighting structure by:
responsive to determining that the agricultural work vehicle is the first type of agricultural work vehicle:
automatically access a first type lighting algorithm configured to control the lighting structure at least partly during operation of the first type of agricultural work vehicle; and
automatically control the lighting structure for the first type of agricultural work vehicle according to the first type lighting algorithm; and
responsive to determining that the agricultural work vehicle is the second type of agricultural work vehicle:
automatically access a second type lighting algorithm configured to control the lighting structure at least partly during operation of the second type of agricultural work vehicle; and
automatically control the lighting structure for the second type of agricultural work vehicle according to the first type lighting algorithm.

18. The cab of claim 17, wherein the a first type of agricultural work vehicle comprises a tractor and the second type of agricultural work vehicle comprises a harvester.

19. The cab of claim 17, wherein the control unit is further configured to at least partly automatically determine whether the agricultural work vehicle is performing a first type of driving or a second type of driving; and
wherein the control unit is configured to control the lighting structure by:
responsive to determining that the agricultural work vehicle is performing the first type of driving for the first type of agricultural work vehicle:
automatically access a first type of driving-first type of agricultural work vehicle lighting algorithm for the first type of agricultural work vehicle configured to control the lighting structure at least partly during the first type of driving of the first type of agricultural work vehicle; and
automatically control the lighting structure of the first type of agricultural work vehicle according to the first type of driving-first type of agricultural work vehicle lighting algorithm; and
responsive to determining that the agricultural work vehicle is performing the second type of driving for the first type of agricultural work vehicle:
automatically access a second type of driving-first type of agricultural work vehicle lighting algorithm for the first type of agricultural work vehicle configured to control the lighting structure at least partly during the second type of driving of the first type of agricultural work vehicle; and
automatically control the lighting structure for the first type of agricultural work vehicle according to the second type of driving-first type of agricultural work vehicle lighting algorithm.
responsive to determining that the agricultural work vehicle is performing the first type of driving for the second type of agricultural work vehicle:
automatically access a first type of driving-second type of agricultural work vehicle lighting algorithm for the second type of agricultural work vehicle configured to control the lighting structure at least partly during the first type of driving of the second type of agricultural work vehicle; and
automatically control the lighting structure of the second type of agricultural work vehicle according to the first type of driving-second type of agricultural work vehicle lighting algorithm; and
responsive to determining that the agricultural work vehicle is performing the second type of driving for the second type of agricultural work vehicle:
automatically access a second type of driving-second type of agricultural work vehicle lighting algorithm for the second type of agricultural work vehicle configured to control the lighting structure at least partly during the second type of driving of the second type of agricultural work vehicle; and
automatically control the lighting structure for the second type of agricultural work vehicle according to the second type of driving-second type of agricultural work vehicle lighting algorithm.

20. An agricultural work vehicle comprising:
a cab comprising:
a cab frame being modular in design and including a frame structure which has a plurality of A-pillars positioned in a front region of the cab and a plurality of B-pillars positioned in a rear region of the cab, wherein the plurality of A-pillars are connected to each other, the plurality of B-pillars are connected to each other, and the plurality of A-pillars are connected to the plurality of B-pillars at respective ends by frame segments extending in a longitudinal direction and in a transverse direction of the cab, wherein the cab frame comprises a lighting structure comprising a plurality of individual light modules;
a cab roof, wherein the plurality of A-pillars and the plurality of B-pillars are positioned substantially vertically and configured to support the cab roof; and
a control unit configured to:
determine whether the agricultural work vehicle is travelling on field travel or road travel;
responsive to determining that the agricultural work vehicle is travelling on the field travel:
access a field travel lighting algorithm; and
control the plurality of individual light modules according to the field travel lighting algorithm; and
responsive to determining that the agricultural work vehicle is travelling on the road travel:
access a road travel lighting algorithm; and
control the plurality of individual light modules according to the road travel lighting algorithm.

21. The agricultural work vehicle of claim 20, wherein the control unit is further configured to at least partly automatically determine whether the agricultural work vehicle is a tractor or a harvester; and
wherein the control unit is configured to control the lighting structure by:
responsive to determining that the agricultural work vehicle is a tractor travelling on the field travel:
automatically access a tractor-field driving lighting algorithm configured to control the lighting structure at least partly during operation of the tractor; and
automatically control the lighting structure for the tractor according to the tractor-field driving lighting algorithm;
responsive to determining that the agricultural work vehicle is a tractor travelling on the road travel:
automatically access a tractor-road driving lighting algorithm configured to control the lighting structure at least partly during operation of the tractor on a road; and
automatically control the lighting structure for the tractor according to the tractor-road driving lighting algorithm;
responsive to determining that the agricultural work vehicle is a harvester travelling on the field travel:
automatically access a harvester-field driving lighting algorithm configured to control the lighting structure at least partly during operation of the harvester on a field; and
automatically control the lighting structure for the harvester according to the harvester-field driving lighting algorithm; and
responsive to determining that the agricultural work vehicle is a harvester travelling on the road travel:
automatically access a harvester-road driving lighting algorithm configured to control the lighting structure at least partly during operation of the harvester on the road; and
automatically control the lighting structure for the harvester according to the harvester-road driving lighting algorithm.
